(19) United States
(12) Patent Application Publication
(10) Pub. No.: US 2008/0251055 A1
(43) Pub. Date: Oct. 16, 2008

(54) EVAPORATIVE EMISSIONS CONTROL SYSTEM

(75) Inventors: Jacob Schmalz, Milwaukee, WI (US); John Gulke, Fond du Lac, WI (US); Elliot Matel, Milwaukee, WI (US)

Correspondence Address: MICHAEL BEST & FRIEDRICH LLP, 100 E WISCONSIN AVENUE, Suite 3300, MILWAUKEE, WI, 53202, US

(73) Assignee: BRIGGS & STRATTON CORPORATION, Wauwatosa, WI (US)

(21) Appl. No.: 12/045,911

(22) Filed: Mar. 11, 2008

Related U.S. Application Data
(63) Continuation-in-part of application No. 11/787,360, filed on Apr. 16, 2007.
(60) Provisional application No. 61/002,496, filed on Nov. 9, 2007.

(51) Int. Cl. F02M 33/02; B65D 51/24; B65D 51/16

(52) U.S. Cl. 123/519; 220/212; 220/367.1

(57) ABSTRACT

An evaporative emissions control system for an engine including a fuel tank having a fuel tank vapor space, a carburetor coupled to the fuel tank, and a fuel tank cap having fuel vapor adsorption media that adsorbs vapor from the fuel tank vapor space. The fuel tank cap is in fluid communication with the carburetor via the vapor space and is configured to permit fuel vapor stored in the fuel adsorption media to be purged into the carburetor via the vapor space.

### CROSS-REFERENCE TO RELATED APPLICATIONS

The present patent application claims priority to U.S. Provisional Patent Application Ser. No. 61/002,496, titled “EVAPORATIVE EMISSIONS CONTROL SYSTEM,” filed on Nov. 9, 2007, and is a continuation-in-part of co-pending U.S. patent application Ser. No. 11/787,360, titled “EVAPORATIVE EMISSIONS CONTROL SYSTEM,” filed on Apr. 16, 2007, the entire contents of all of which are hereby incorporated by reference.

### BACKGROUND

The present invention relates to an evaporative emissions control system for capturing evaporative emissions from fuel tanks or other engine components.

Internal combustion engines are often used to power small equipment such as lawnmowers, tillers, snow throwers, lawn tractors and the like. The fuel system includes a tank, in which fuel is stored for use. Generally, the volatility of the fuel allows a portion of the fuel to evaporate and mix with air within the tank. Changes in temperature, such as those between evening and daytime, as well as sloshing during use can cause an increase or a decrease in the amount of fuel vapor in the tank as well as an increase or a decrease in the pressure within the tank.

To accommodate these pressure changes, fuel tanks often include a vent such as a vented fuel cap. The vent allows the excess air and fuel vapor to escape the tank when the pressure increases. The vent also allows air to enter the tank when the pressure drops. Pressure within the fuel tank typically drops as fuel is drawn from the tank for use.

### SUMMARY

In one embodiment, the invention provides an evaporative emissions control system for an engine including a fuel tank having a fuel tank vapor space, a carburetor coupled to the fuel tank, and a fuel tank cap having fuel vapor adsorption media that adsorbs vapor from the fuel tank vapor space. The fuel tank cap is in fluid communication with the carburetor via the vapor space and is configured to allow fuel vapor stored in the fuel adsorption media to be purged into the carburetor via the vapor space.

In another embodiment, the invention provides a fuel tank cap for a fuel tank of an engine. The fuel tank cap includes a cap housing configured to contain a fuel vapor adsorption media and a mounting apparatus configured to retain a fuel additive capsule.

Other aspects of the invention will become apparent by consideration of the detailed description and accompanying drawings.

### BRIEF DESCRIPTION OF THE DRAWINGS

The detailed description particularly refers to the accompanying figures in which:

FIG. 1 is a perspective view of a lawn mower, including an engine;

FIG. 2 is a perspective view of an evaporative emissions control system having a carburetor coupled to a fuel tank;

FIG. 3 is a cross-sectional view of the evaporative emissions control system of FIG. 2, taken along line 3-3 of FIG. 2;

FIG. 4 is an exploded perspective view of the evaporative emissions control system of FIG. 3;

FIG. 5 is a schematic illustration of the evaporative emissions control system of FIG. 3;

FIG. 6 is a perspective view fuel tank venting system of FIGS. 2 through 5;

FIG. 7 is a cross-sectional view of the fuel tank venting system of FIG. 6, taken along line 7-7 of FIG. 6;

FIG. 8 is an exploded perspective view of the fuel tank venting system of FIG. 7;

FIG. 9 is a schematic illustration of the fuel tank venting system of FIG. 7; and

FIG. 10 is a top perspective view of the filter attachment device of the present invention.

FIG. 11 is a cross-sectional view of the fuel tank venting system of FIG. 6, taken along line 11-11 of FIG. 6;

FIG. 12 is a top perspective view of a fuel tank cover of an evaporative emissions control system according to the present invention.

FIG. 13 is a cross-section view of the fuel cap of FIG. 12, including a fuel vapor adsorption media, taken along line 13-13 of FIG. 12, and further depicting the evaporative emissions control system of FIG. 2.

FIG. 14A is a top exploded view of the fuel cap of FIG. 13.

FIG. 14B is a bottom exploded view of the fuel cap of FIG. 13.

FIG. 15 is a cross-sectional view of the fuel cap of FIG. 13 positioned on the fuel tank.

FIG. 16 is the cross-sectional view of FIG. 15 depicting fuel vapor flow paths.

FIG. 17 is a cross-sectional view of the fuel cap of FIG. 12 having a fuel vapor adsorption media and an apparatus to deliver a fuel additive to the fuel tank, and positioned on the fuel tank.

FIG. 18 is an exploded bottom view of the fuel cap of FIG. 17.

FIG. 19 is a cross-sectional view of the fuel cap of FIG. 17 positioned on the fuel tank.

FIG. 20 is the cross-sectional view of FIG. 19 depicting fuel vapor flow paths.

FIG. 21 is a bottom view of the fuel cap of the present invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

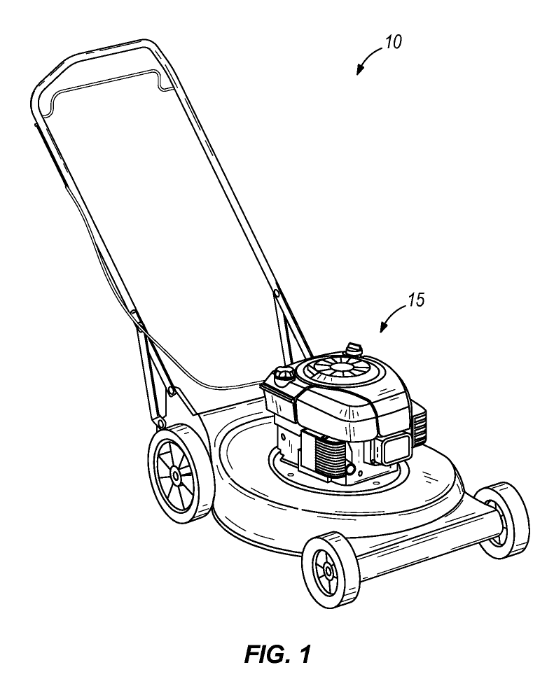

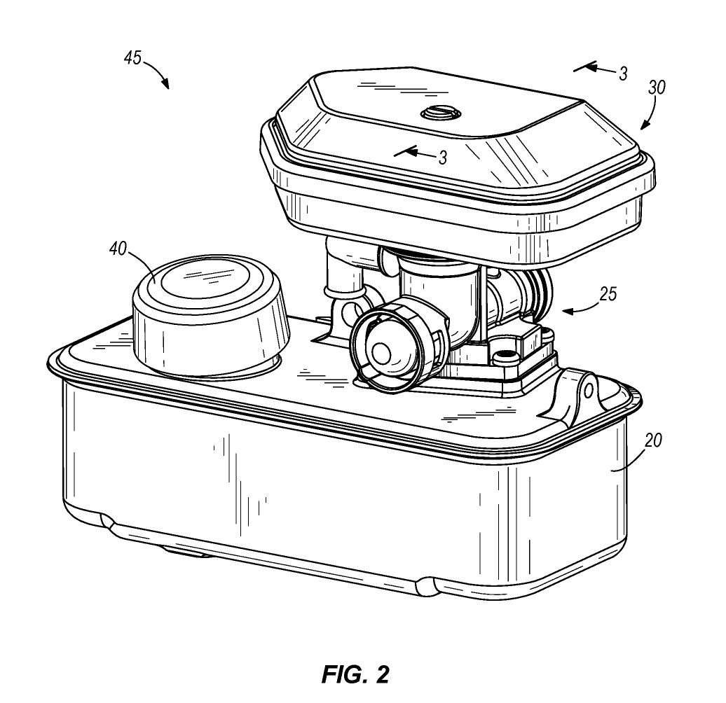

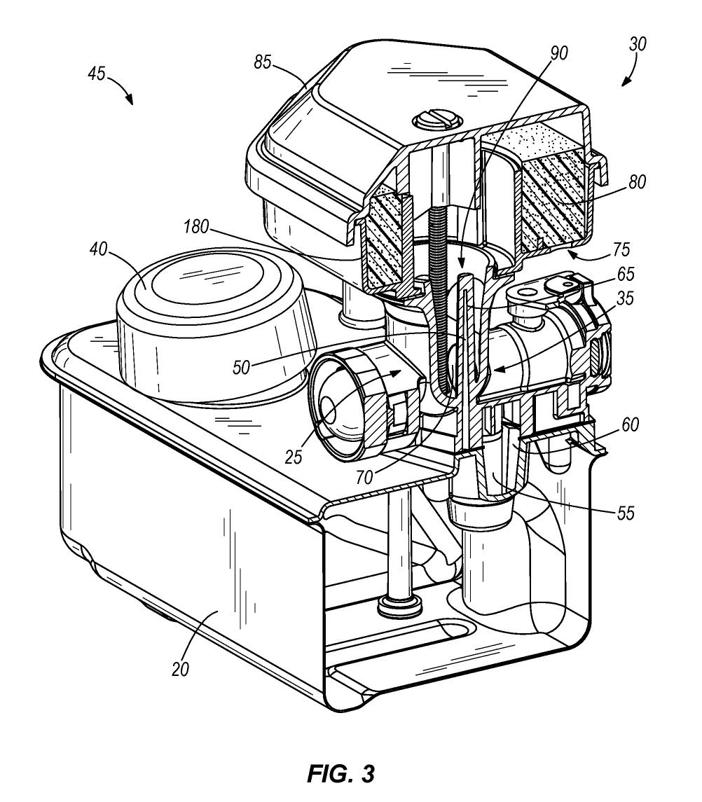

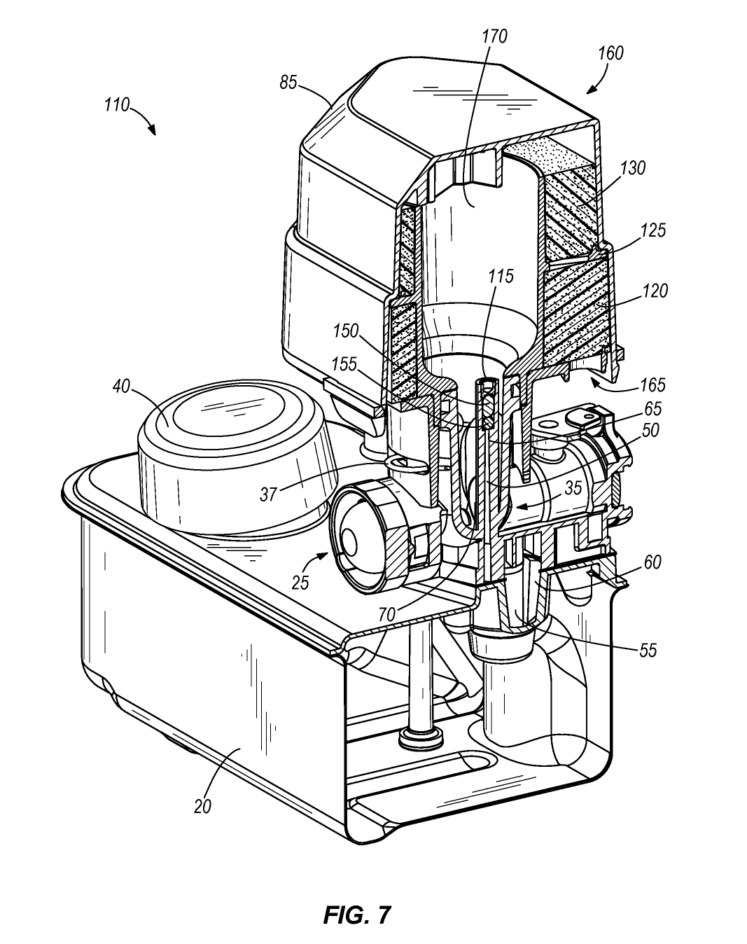

With reference to FIG. 1, a lawn mower 10 including an engine 15 is illustrated. To properly operate the engine 15, the lawn mower 10 also includes a fuel tank 20, an air-fuel mixing device 25 and an air filter 30 (illustrated in FIGS. 2-9). Generally, the air-fuel mixing device 25 includes a carburetor 35, as illustrated in FIGS. 3 and 7, but it could also be a throttle body or other component of a fuel injection system. The engine 15 may be used to power outdoor power equipment such as lawnmowers, garden tractors, snow throwers, tillers, pressure washers, generators, and the like.

Typically, the fuel tank 20 is sized based on the size of the engine 15 and the task to be performed by the device to which the engine 15 and the fuel tank 20 are attached. Thus, a variety of fuel tank sizes are available. As one of ordinary skill in the art will realize, several fuel tanks of different sizes can be used with engines. As such, the invention described herein should not be limited to use with fuel tanks sized as described herein. Rather, the invention is applicable to different fuel tanks in addition to those discussed. However, it should be understood that embodiments of the invention using carbon-impregnated foam may be limited practically to engines using smaller fuel tanks (less than 1 liter), due to the practical size limitations of the carbon-impregnated foam for large fuel tanks, such that as the size of the fuel tank increases, the size of the carbon-impregnated foam increases accordingly. The fuel fill port is sealed with a fuel tank cap 40 in a way that restricts or prevents fluid flow through the port under normal static and operating conditions. The fuel cap 40 could be non-vented or alternatively be control-vented, whereby the fuel cap 40 is sealed during the diurnal cycle. The fuel cap may include a pop valve, wherein the valve could pop up to release pressure in the event of increased pressure. As more fully discussed below, the present invention includes a vented fuel cap having a fuel vapor adsorbent media therein.

With reference to FIGS. 2 and 3, an evaporative emissions control system 45 is shown. The evaporative emissions control system 45 includes a fuel tank 20, fuel tank cap 40, a fuel tank vent passageway 50, a carburetor 35, and an air filter assembly 30. The fuel tank 20, fuel tank vent passageway 50 and carburetor 35 are in fluid flow communication with each other. The carburetor 35 is attached to the fuel tank 20. The fuel tank 20 and carburetor 35 may be formed by a plurality of materials, including, but not limited to, plastic, metal, composite, and the like. Manufacturing processes available to form the fuel tank include, but are not limited to vacuum-forming, roto-molding, blow-molding, injection molding and the like. The fuel tank 20 further includes a fuel tank reservoir 55. The fuel tank reservoir 55 is integrally-formed with the top portion of the fuel tank 20. A gasket 60 on the top of the fuel tank 20 provides the seal between the passages on the carburetor 35 and the top portion of the fuel tank 20.

As discussed above, the air fuel mixing device 25 typically includes the carburetor 35 that could be a float carburetor, a diaphragm carburetor or any other type of carburetor. The air-fuel mixing device 25 extends from the fuel tank 20 to the filter assembly 30. The carburetor 35 includes a restrictor 65 (shown in FIG. 3). The restrictor 65 may be a cup plug press-fit into the fuel tank vent passageway 50 of the carburetor 35 or may be molded directly into the fuel tank vent passageway 50. The diameter of the restrictor is maintained near the minimum diameter for sufficient vent efficiency of the fuel tank during engine operation while still providing vented emission restriction while static. If the diameter of the restrictor is too small, expanding vapors in the tank would not be allowed to leave the fuel tank, causing the fuel tank to pressurize, thereby creating an air/fuel ratio too rich for engine operation. Also, if the diameter is too small, vacuum created by fuel consumption when the engine has reached steady state temperatures could not be relieved, causing a lean air/fuel ratio, resulting in engine stumbling or reduced power. If the diameter of the restrictor is too large, the evaporative emissions released when the engine is static will not be sufficiently controlled. A low water pressure differential is maintained between the carburetor throat and the fuel tank to allow the correct amount of fuel to be drawn into the carburetor for proper engine operation.

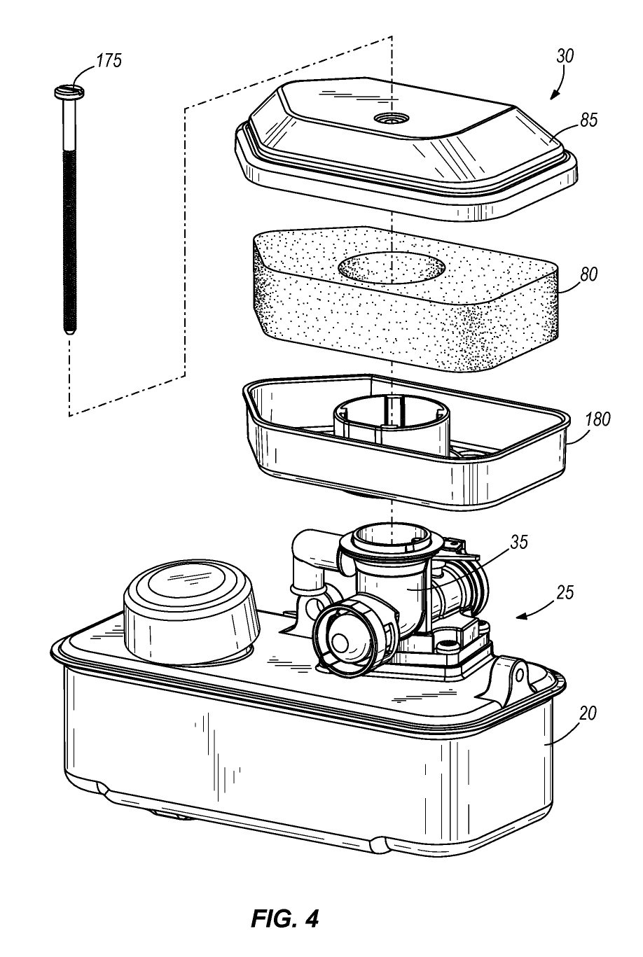

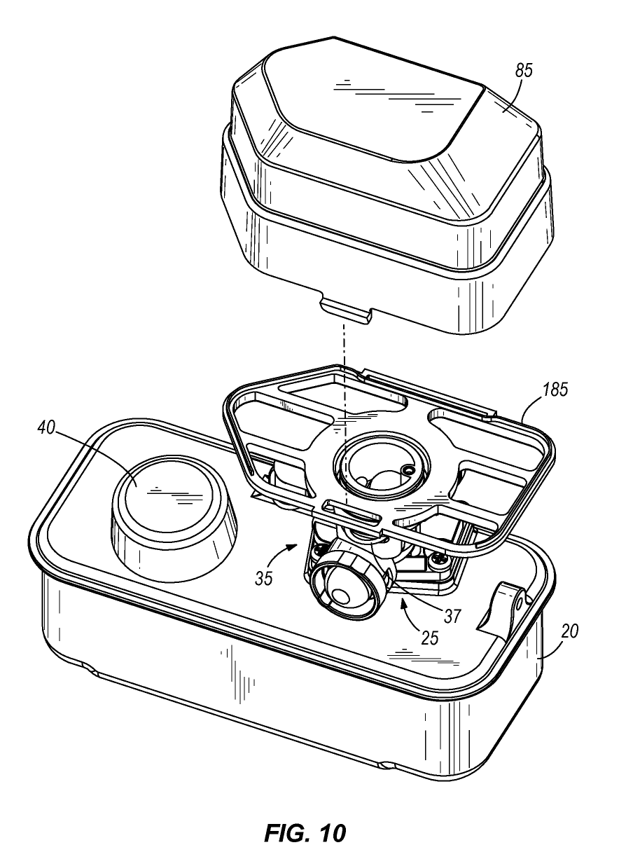

With reference to FIGS. 3 and 4, the air filter assembly 30 includes an air intake 75, an air filter element 80, a filter cover 85, a filter base 180, and a fastener 175. The fastener 175 couples the components of the filter assembly together. The fastener 175 is shown as a screw, but it may be a threaded rod, bolt or similar fastening apparatus. The air filter assembly 30 is in fluid communication with the carburetor 35 via a central passageway 90 in the air filter assembly 30. As illustrated in FIG. 10, a filter connector 185 is preferably attached to the carburetor 35 using a locking clip 37, or similar fastening device. The filter cover 85 is preferably snap-fit onto the filter base 180. Other processes are available to couple the filter to the carburetor, including but not limited to using screws, threaded rods, or similar fastening devices. The air filter element 80 includes a non-carbon foam element. In some embodiments, the air filter element may include a paper filter or other type of filtering element.

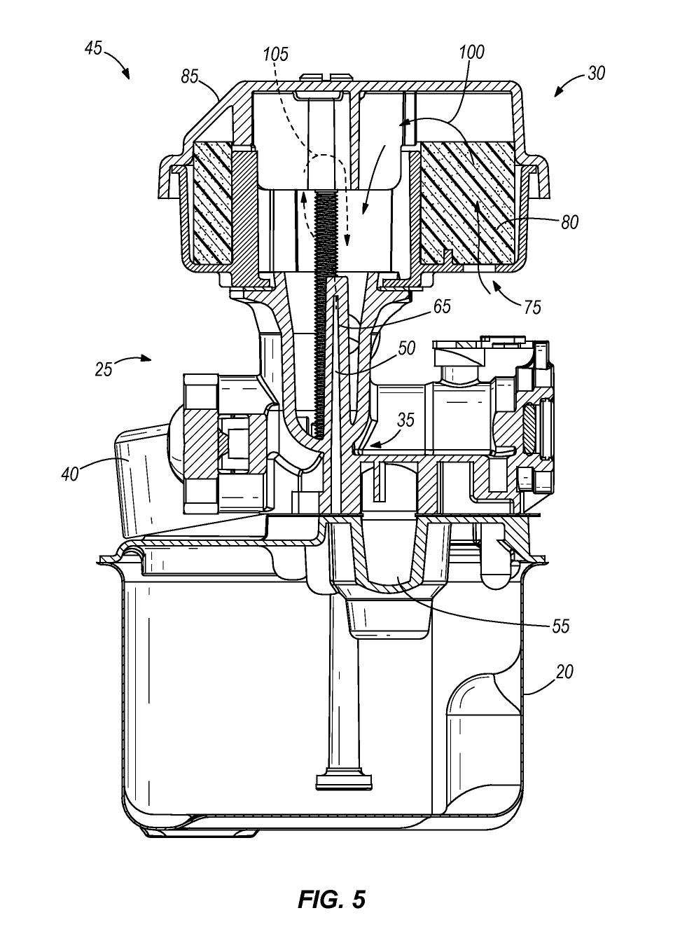

In operation and with reference to FIG. 5, when a piston of the engine is moving downward during the intake stroke, the intake valve opens, which reduces the pressure in the carburetor throat 70. The resulting reduced pressure in the evaporative emissions control system 45 causes air to be pulled into the air filter assembly 30 through the air intake 75 into the first air flow path 100. First air flow path 100 begins at or near the air intake 75 and passes through the air filter element 80. First air flow path 100 then enters the carburetor 35. At the same time, any vapors emitted from the fuel tank 20 while the engine is running are sent back into the carburetor 35 via the fuel tank vent passageway 50 in a second air flow path 105 in combination with the first air flow path 100.

When the engine is at rest, the fuel tank 20 continues to emit vapors through the carburetor 35 into the air filter assembly 30. The air filter element 80 and gravity substantially reduce the vapors released externally from the system because the air intake 75 is generally at a higher elevation than the carburetor 35. The density of the vapors should minimize the amount of vapor from the fuel tank 20 present in the air filter assembly 30 from exiting the air filter assembly 30. Sizing of the restrictor may also aid in reducing the quantity of vapor emitted by the fuel tank 20 through the fuel tank vent passageway 50 and out to the atmosphere via the air filter assembly 30. The system 45 controls vapor emissions during engine operation, and may also reduce vapor emissions while the engine is at rest.

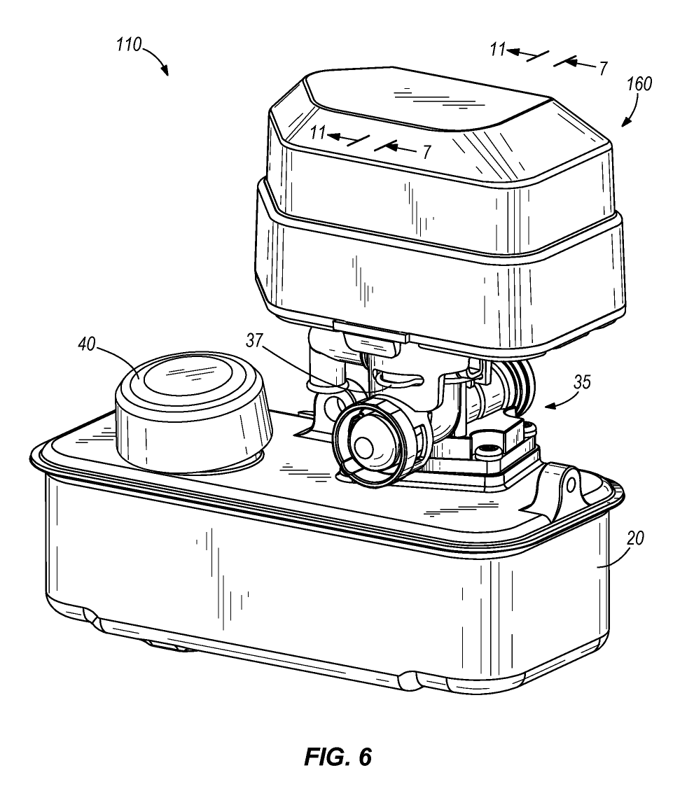

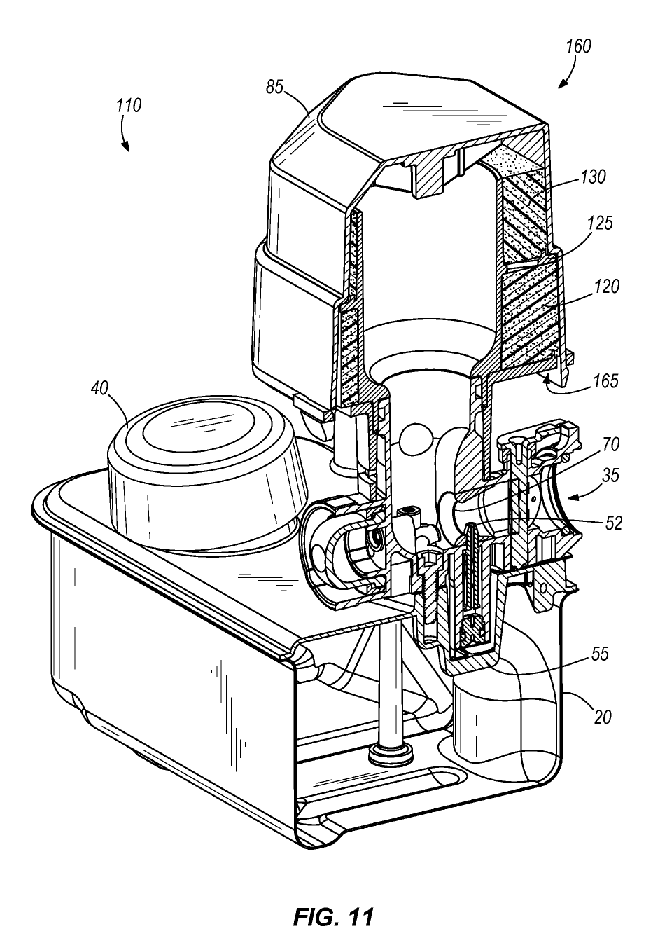

With reference to FIGS. 6 and 7, a fuel tank venting system 110 is shown. The fuel tank venting system 110 includes a fuel tank 20, a fuel tank cap 40, a fuel tank vent passageway 50, a carburetor 35 (similar to the fuel tank and carburetor of FIGS. 2-5), and an air filter assembly 160. The fuel tank venting system 110 may include a rollover valve 115 or other liquid-vapor separation device. The fuel tank 20, fuel tank vent passageway 50 and carburetor 35 are in fluid flow communication. The carburetor 35 is attached to the fuel tank 20. As illustrated in FIG. 11, a primary fuel nozzle 52 has its outlet in the carburetor throat 70.

The fuel tank 20 further includes a fuel tank reservoir 55. The fuel tank reservoir 55 is integrally-formed with the top portion of the fuel tank 20. A gasket 60 on the top of the fuel tank 20 provides a seal between the passages on the bottom of the carburetor 35 and the top portion of the fuel tank 20. The carburetor 35 includes a restrictor 65 (shown in FIG. 7). The restrictor 65 may be a cup plug press-fit into the fuel tank vent passageway 50 of the carburetor 35 (when using a roll-over valve 115) or may be molded directly into the fuel tank vent passageway 50 (when a roll-over valve 115 is not present). The diameter of the restrictor is selected to be the minimum diameter for sufficient vent efficiency for the fuel tank. The diameter of the restrictor is maintained near the minimum diameter for sufficient vent efficiency of the fuel tank during running while still providing vented emission restriction while static. If the diameter of the restrictor is too small, expanding vapors in the tank would not be allowed to leave the fuel tank, causing the fuel tank to pressurize, thereby creating an air/fuel ratio too rich for engine operation. Also, if the diameter is too small, vacuum created by fuel consumption when the engine has reached steady state temperatures could not be relieved, causing a lean air/fuel ratio, resulting in engine stumbling or reduced power. If the diameter of the restrictor is too large, the evaporative emissions released when the engine is static will not be sufficiently controlled. The low water pressure differential is maintained to allow the correct amount of fuel to be drawn into the carburetor for proper engine operation.

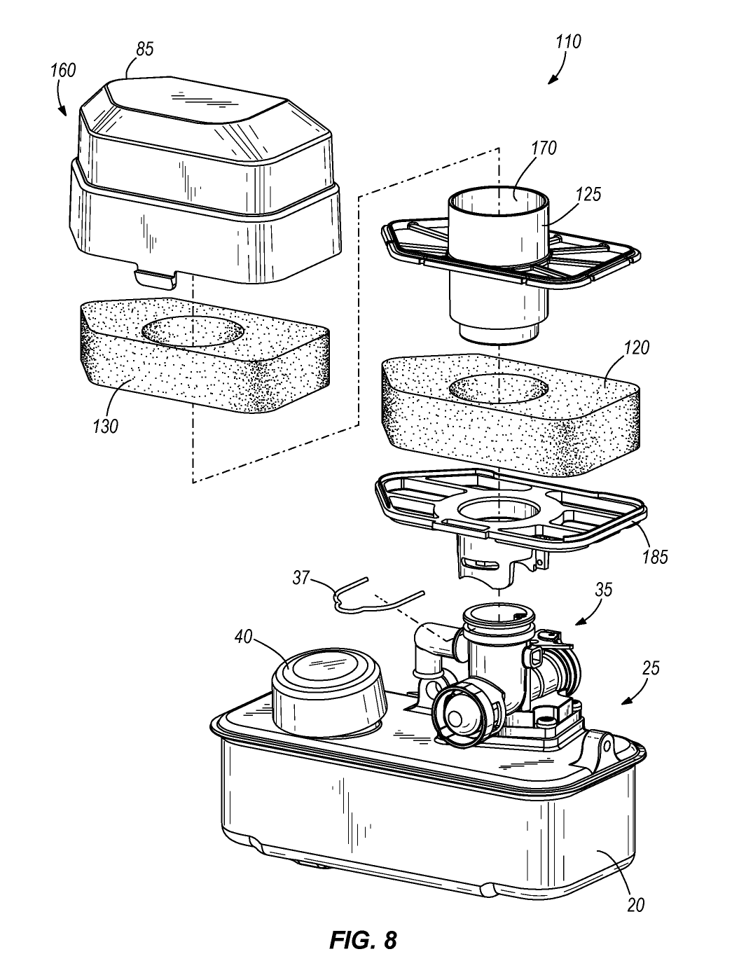

As illustrated in FIGS. 7 and 8, the air filter assembly 160 includes a first stage air filter element 120, a frame 125, a second stage air filter element 130, a filter cover 85, a filter base 185, and an air intake 165. The air filter assembly 160 is in fluid communication with the carburetor 35 via a central passageway 170 in the filter assembly 160. The air intake 165 is integral to the filter connector 185. The first stage air filter element 120 consists of a non-carbon foam element. The frame 125 separates the first stage air filter element 120 and the second stage air filter element 130. The frame 125 can be manufactured by injection-molding of a plastic material or like process. The second stage air filter element 130 consists of a carbon-impregnated foam element. The density of the carbon-impregnated foam element is preferably less than the density of carbon elements found in a typical carbon canister filter. A low density in the carbon-impregnated foam element of the second stage air filter element 130 decreases the restriction of intake air flow for the engine. As the size of the fuel tank increases, the amount of vapor that must be captured by the carbon also increases. Because of the foam's low density, the size of the air filter needed to capture these vapors could increase to an impractical size. As a result, there is a practical limit to the size of the engine on which the two-stage air filter may be used.

In a preferred embodiment, the air filter is configured in a stacked position, with the first stage air filter element 120 adjacent to and positioned at a lower elevation than the second stage air filter element 130. However, in other embodiments, the air filter is in a series arrangement by the air intake, with the first stage foam element adjacent to the carbon-impregnated foam element in the second stage, with the air intake passing through the first stage before passing through the second stage.

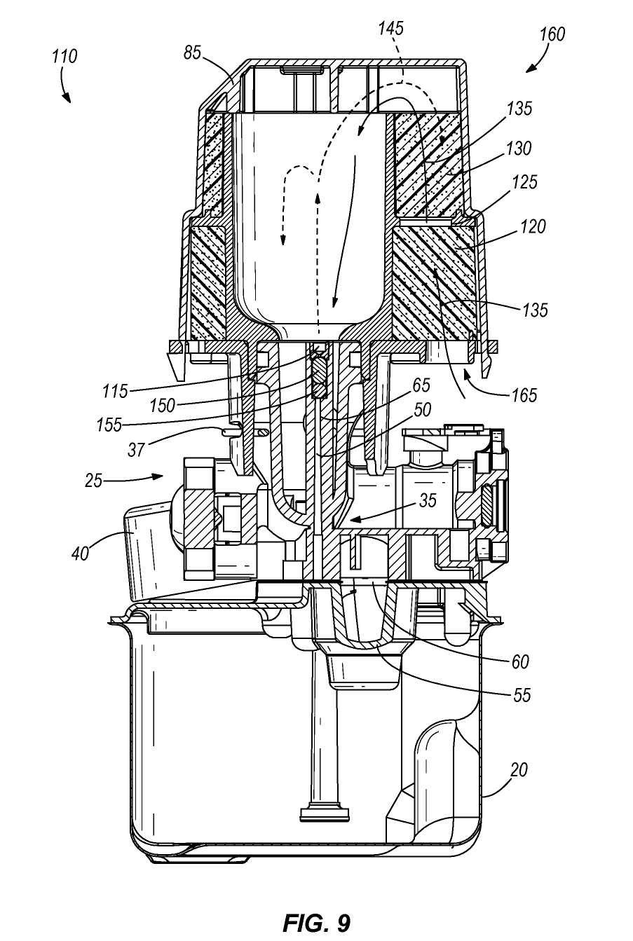

In operation and with reference to FIG. 9, the fuel tank venting system 110 controls evaporative emissions when the engine is running and while the engine is at rest. When the engine is running, the evaporative emissions control system 110 captures vapors and evaporative emissions from fuel tank 20. When the engine is running, a partial vacuum is created in the carburetor throat 70 when the intake valve opens, which sends the vapors to the carburetor 35 for ingestion into the combustion chamber.

More specifically, when the piston is moving downward during the intake stroke, the intake valve of the engine opens, which reduces the pressure in the carburetor throat 70. The resulting reduced pressure in the fuel tank venting system 110 causes air to be pulled into the air filter assembly 160 through the air intake 165 in the filter connector 185 into a third air flow path 135. At the same time, any vapors previously emitted from the fuel tank 20 that are adsorbed in the second stage air filter element 130 while the engine is at rest are sent back into the carburetor 35 through a fourth air flow path 140.

When the engine is at rest, the fuel tank 20 continues to vent, with gravity keeping a portion of the evaporative emissions from exiting the air filter assembly 160. However, some vapors emitted though the fourth air flow path 140 continue through a fifth air flow path 145 to the air filter assembly 160 and are adsorbed by the second stage air filter element 130 and retained on the surface of the carbon in the carbon-impregnated foam element. The carbon-impregnated foam element captures substantially all of the evaporative emissions from the fuel tank 20 in the fifth air flow path 145. When the engine is running again, the evaporative emissions from the fourth air flow path 140 are sent back into the carburetor 35 for ingestion along with the air and vapors from the third air flow path 135.

In one embodiment, the roll-over valve 115, or other liquid-vapor separation device, is positioned in the fuel tank vent passageway 50 of the carburetor 35. The roll-over valve 115 may be a one-way check valve. The roll-over valve 115 is configured to prevent liquid fuel from the fuel tank 20 from entering the filter or leaving the tank when the engine is tipped too much. In some embodiments, a roll-over valve is not present. As shown in FIGS. 7 and 9, the fuel venting system 110 includes a capsule 150 and a ball 155. The capsule 150 is disposed in the fuel tank vent passageway 50 to prevent liquid fuel from spilling into the filter when the engine is tilted greater than about 30 degrees. The ball 155 also prevents liquid fuel from leaving the fuel tank in the event of a complete roll-over.

Another protection against spillage is the sealed fuel cap 40. When venting is permitted through a threaded fuel cap, less tilt of the engine is necessary before liquid fuel is spilled. However, with a sealed fuel cap and venting through the fuel tank vent passageway 50, the engine can be in a more tilted position before liquid fuel will spill.

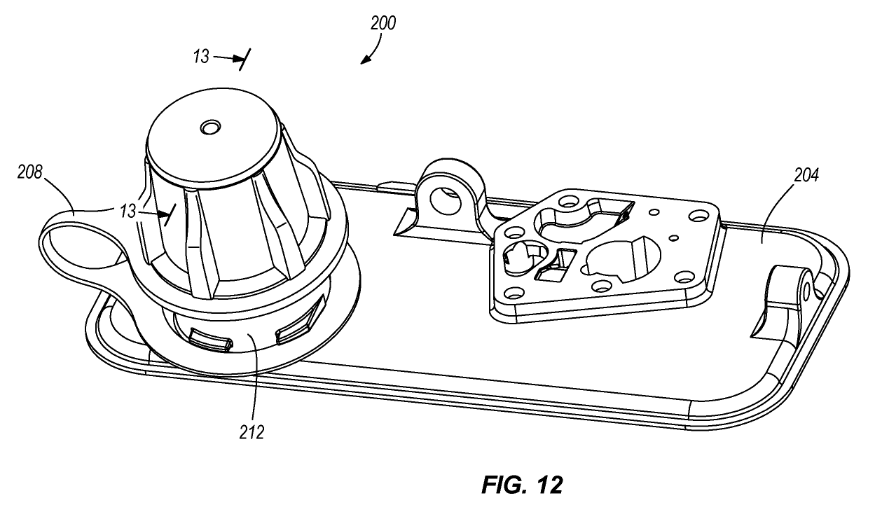

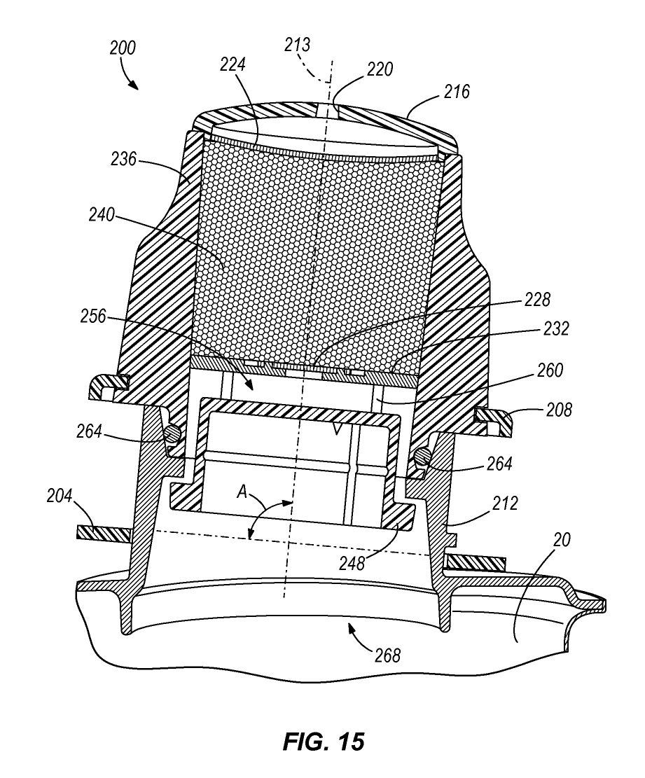

FIGS. 12 through 16 illustrate embodiments of the evaporative emissions control system of the present invention including a vented fuel cap 200. FIG. 12 shows a fuel tank cover 204 configured for the carburetor of FIGS. 2 through 12. The fuel tank cover 204 further includes a fuel tank cap 200 having a tether 208. The tether 208 is adapted to allow the fuel tank cap 200 to be removably attached to the filler neck 212 extending from the fuel tank cover 204, and tethered so that it remains coupled to the fuel tank cover 204 to prevent loss of the fuel tank cap 200 when it is removed from a filler neck 212 of the fuel tank 20 during refueling.

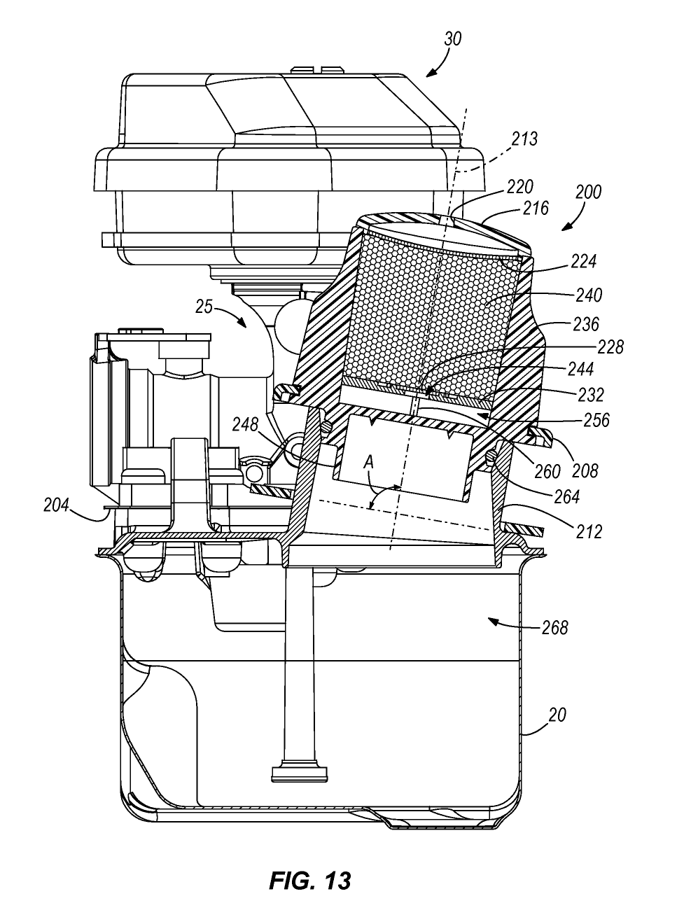

FIG. 13 includes a cross-sectional view of the fuel cap of FIG. 12, taken along line 13-13 of FIG. 12. The fuel tank cap 200 includes a cap 216 with an ambient vent 220, a first screen 224, a second screen 228, a restrictor 232, a cap housing 236, and a fuel vapor adsorption media 240. The restrictor 232 is configured to secure the second screen 228 by heat staking, although it could be secured by other means such as adhesives or fasteners. The cap housing 236, when coupled to the cap 216 via weld, adhesive, fasteners or other means, is configured to retain the first screen 224, the second screen 228, restrictor 232 assembly and a fuel vapor adsorbent media 240. The cap housing 236 is further configured to interlock with and be removably coupled to the filler neck 212 of the fuel tank 20. A gasket 264 provides a further seal between cap housing 236 and filler neck 212. The filler neck 212, and particular, its longitudinal axis 213 (see FIG. 13), is positioned to make a non-zero acute angle A with respect to the fuel tank cover 204 so that any liquid fuel that makes its way into fuel cap 200 will have a means for draining back into fuel tank 20 via gravity.

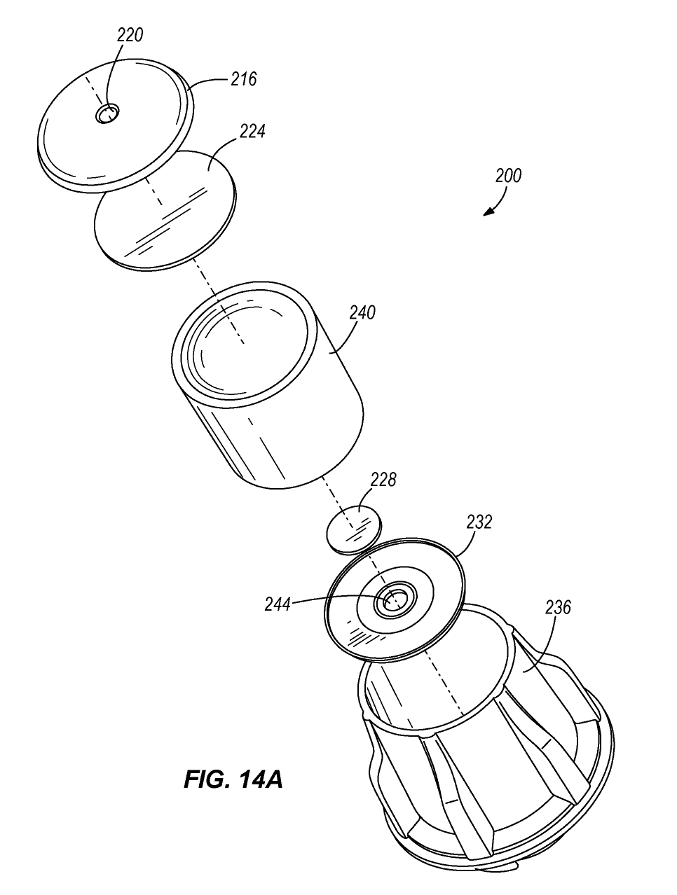

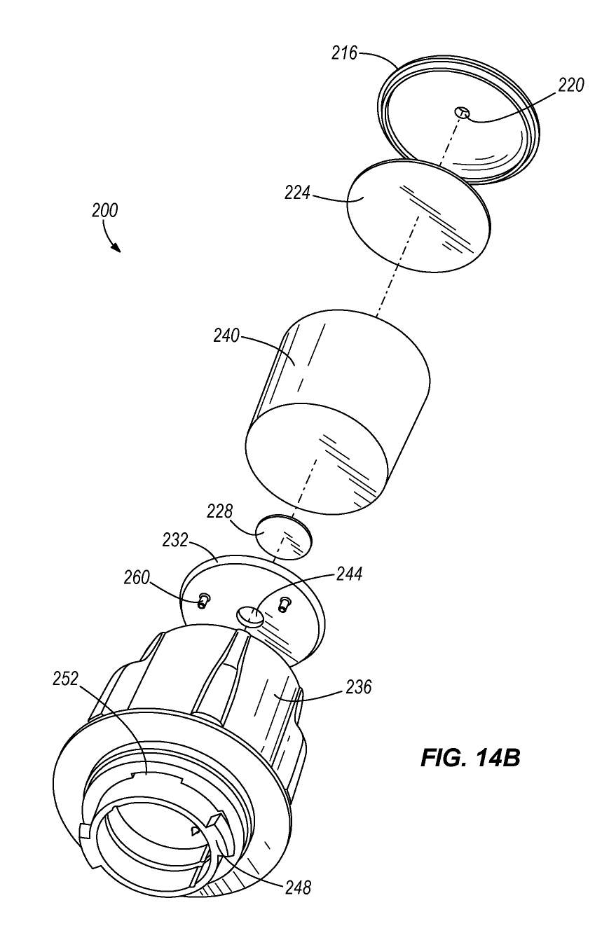

In the illustrated embodiment shown in FIGS. 14A through 16, the fuel vapor adsorption media 240 is carbon. In other embodiments, the fuel vapor adsorption media can be another adsorption media capable of adsorbing fuel vapor. In the illustrated embodiment, the fuel vapor adsorption media 240 is retained by the first screen 224, the second screen 228, and the restrictor 232. The ambient vent 220 is substantially centrally positioned in the cap 216. This vent is sized in order to allow for adequate venting without compromising the flow restriction that is necessary for adequate emissions control. In other embodiments, the ambient vent 220 may be in other locations on the fuel cap 216 that allow venting to the atmosphere. In the illustrated embodiment, the first screen 224 is a concave screen that retains and compresses the fuel vapor adsorption media 240. In other embodiments, the first screen may be any shape screen that will compress and retain the fuel vapor adsorption media. The second screen 228 is shown as a substantially planar screen. However, in other embodiments, the second screen may be any shape screen that will compress and retain the fuel vapor adsorption media. The relationship of the second screen 228 and restrictor 232 is such that when the fuel tank cap 200 is assembled, the fuel vapor adsorbent media 240 resides as close to the restrictor aperture 244 as possible. The first screen 224 and second screen 228 also prevent the fuel vapor adsorption media from rubbing or otherwise wearing against itself or other components of the cap. The first screen 224 and second screen 228 are made of stainless steel to provide rigidity and prevent corrosion. In other embodiments, the screens could be made of plastics or other materials that provide stiffness and corrosion protection.

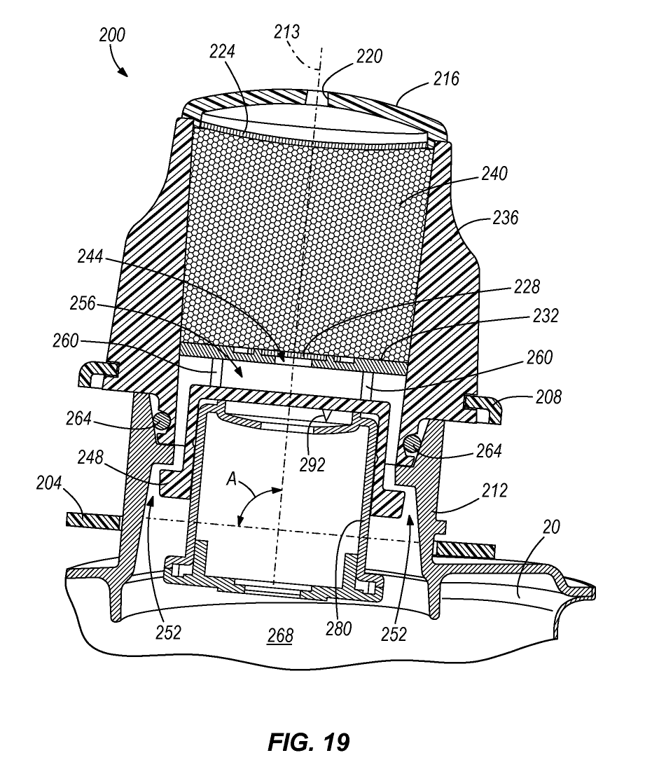

The fuel cap 200 further includes the restrictor 232. The sealed restrictor 232 prevents liquid fuel from having a direct path to the fuel vapor adsorbent media 240 and provides a path for fuel vapors. When installed in the cap housing 236, the restrictor 232 is radially sealed by an interference fit between the restrictor outer diameter and cap housing inner diameter. In other embodiments, this seal may be made by other means such as welding or the use of an adhesive. The restrictor 232 includes an aperture 244. The aperture is sized so that, when coupled with the screen, it allows for sufficient venting without compromising the flow restriction that is necessary for adequate emissions control. The restrictor 232 is preferably manufactured from acetyl plastic. However, in other embodiments, the restrictor can be manufactured from other plastics or another fuel-resistant material. The aperture 244 is centrally located in the restrictor 232 to force the vapor from the fuel tank 20 to enter the vapor adsorbent media 240 through only the restrictor central aperture 244. The restrictor central aperture 244 essentially forces the fuel vapor to enter the fuel vapor adsorption media 240 at the central axis of the fuel adsorber. This provides the most efficient use of the fuel vapor adsorbent media 240 by forcing the fuel vapor to take a central path through the fuel vapor adsorber bed to the ambient vent 220 so that only substantially clean air is vented to the atmosphere through the ambient vent 220. The fuel tank cap 200 can further include an optional mounting device 248 for any additional apparatus to be coupled to the fuel cap 200, such as a fuel additive apparatus (FIG. 19).

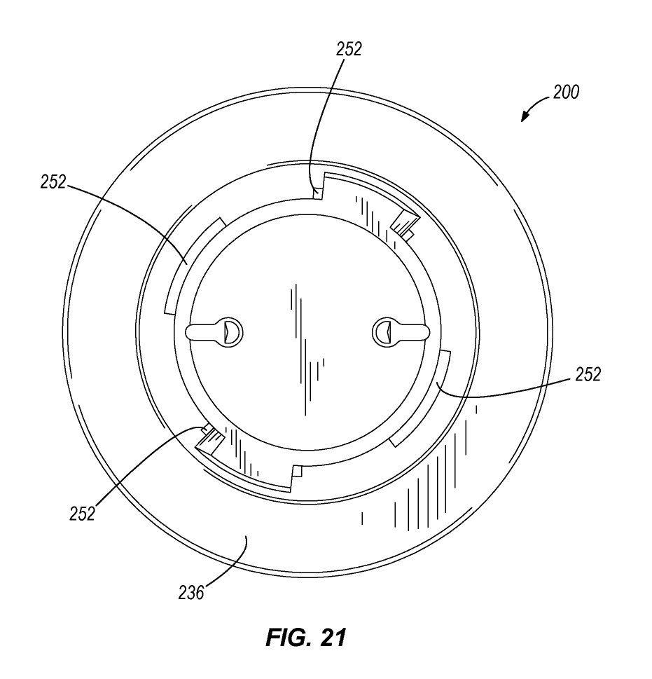

The bottom side of fuel tank cap 200 further includes a plurality of vents 252 as illustrated in FIG. 21. FIG. 21 shows a bottom side of the cap housing 236 of fuel cap 200. The vents 252 are substantially positioned at approximately ninety (90) degrees around the bottom side of the fuel cap 200. The vents 252 allow for vapors to enter the cap 200 from the fuel tank 20 to enter a gap 256. The gap 256 is created by a standoff or standoffs 260 that extend from the restrictor 232. The gap 256 can be created from one, two, three, four or more standoffs 260. The depicted configuration further forces the vapor from the fuel tank 20 to flow through vents 252, through gap 256, and through restrictor aperture 244, to enter the fuel tank cap 200 and the fuel vapor adsorption media 240.

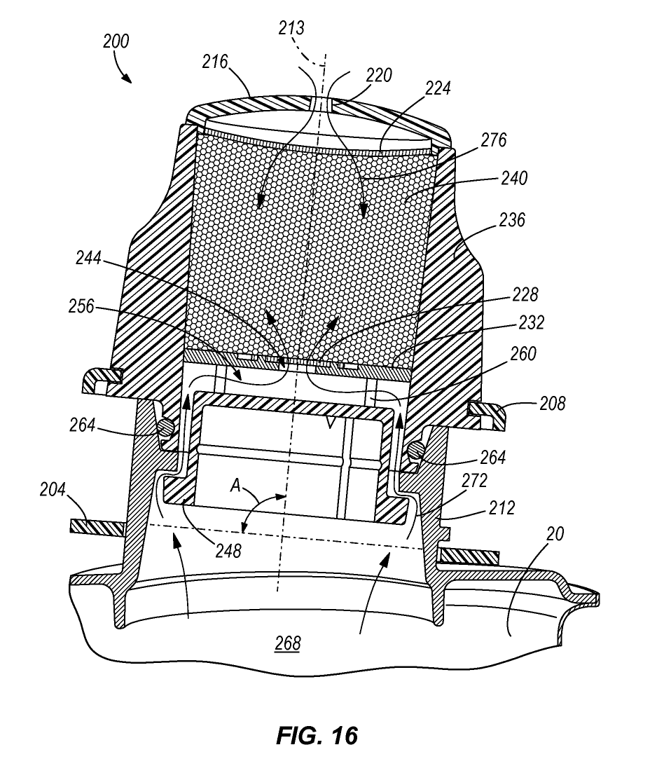

In operation and with reference to FIG. 16, the evaporative emissions fuel tank cap 200 receives and purges fuel vapor in response to the partial pressure pulses created by the operation of the engine and changes in fuel temperature. To filter the tank evaporative emissions, the fuel vapor from the fuel tank 20 in the fuel tank vapor space 268 enters the fuel cap 200 through vents 252, as shown by flow arrows 272. The flow 272 continues through the gap 256 to the restrictor aperture 244. The flow 272 proceeds through the restrictor aperture 244 into the fuel vapor adsorption media 240, wherein the fuel vapor is substantially adsorbed. As a result, only substantially clean air exits the fuel cap 200 through the ambient vent 220.

The fuel vapor adsorption media 240 is purged to the throat of carburetor 35 when the downward movement of a piston of the engine during the intake stroke opens the intake valve to reduce pressure in the carburetor throat 70 (FIG. 11). This reduced pressure is translated to the fuel tank cap vents 252 via the fuel tank vapor space 268 and the vent passageway 50. The resulting reduced pressure in the fuel tank cap 200 causes ambient air to be pulled into the fuel cap 200 through the ambient vent 220, as shown by flow arrows 276, past the fuel vapor adsorbent media 240 and restrictor 232 and out the fuel cap bottom vents 252. The flow 276 causes captured fuel vapor in the fuel vapor adsorption media 240 to be purged from the fuel cap 200 to the tank vapor space 268, through the vent passageway 50, and then into the carburetor throat 70 to be used for combustion. The evaporative emissions control system functions in this manner to both adsorb the fuel vapor and provide the purged vapor to the carburetor for combustion.

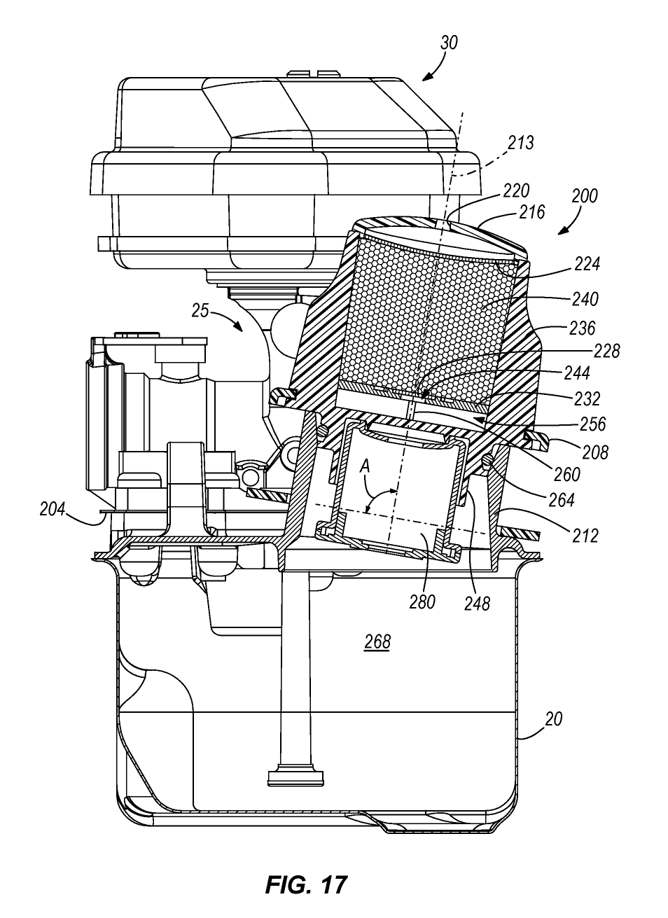

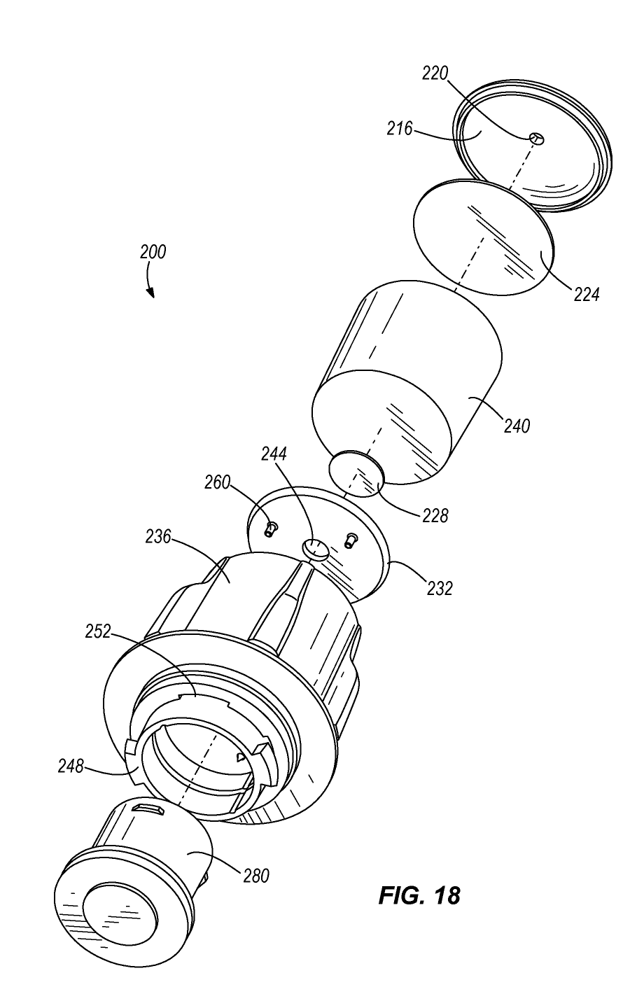

As shown in FIGS. 17 through 20, the fuel tank cap 200 may optionally further include an apparatus 280 to deliver a fuel additive to the fuel tank 20. By way of example only, a similar apparatus to deliver a fuel additive to the fuel tank as illustrated in FIGS. 17 through 20 is described and illustrated in detail in U.S. Pat. No. 6,942,124 and U.S. Pat. No. 6,981,532, which are incorporated herein by reference. As shown in FIGS. 17 through 20, the fuel tank cap includes a cap 216, an ambient vent 220, a first screen 224, a second screen 228, a restrictor 232, a cap housing 236, and vents 252. FIG. 17 shows the fuel tank cap 200 including fuel vapor adsorption media 240. The components operate in substantially similar manner to the components shown in FIGS. 13 through 16. Therefore, like elements are labeled with the same numbers.

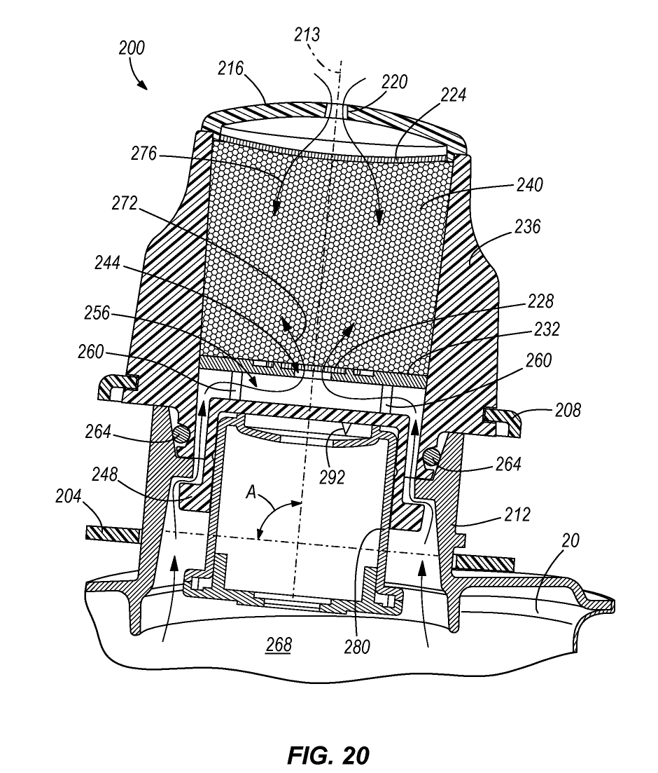

The apparatus 280 is coupled to the bottom of the fuel cap 200 in the mounting device 248 and extends into the filler neck 212 of the fuel tank and the fuel tank 20. In the illustrated embodiment, the apparatus 280 is a capsule that may include liquid fuel stabilizer stored in a chamber of the apparatus. As shown in FIG. 20, the fuel-vapor mixture must flow around the apparatus 280 to enter the vents 252. In some embodiments, the apparatus to deliver a fuel additive to the fuel tank is coupled to the fuel cap; however, there may not be any fuel additive capsule in it.

If a fuel stabilizer capsule is included in mounting apparatus 248, the capsule is designed to automatically drip a small quantity of a fuel stabilizer liquid into the fuel tank 20; see U.S. Pat. Nos. 6,942,124 and 6,981,532. Point or protrusion 292 (FIG. 19) automatically creates a vent hole in the top of the fuel stabilizer capsule, as disclosed in U.S. Pat. Nos. 6,942,124 and 6,981,532. A suitable fuel stabilizer capsule for use with the present invention is sold by Briggs and Stratton Corporation under the trademark FRESH START.

Various features and advantages of the invention are set forth in the following claims.

What is claimed is:

1. An evaporative emissions control system for an engine comprising:
a fuel tank having a fuel tank vapor space;
a carburetor coupled to the fuel tank; and
a fuel tank cap having fuel vapor adsorption media that adsorbs fuel vapor from the fuel tank vapor space.

2. The evaporative emissions control system of claim 1, wherein the fuel tank cap is in fluid communication with the carburetor via the vapor space and is configured to allow fuel vapor stored in the fuel adsorption media to be purged into the carburetor via the vapor space.

3. The evaporative emissions control system of claim 1, wherein the fuel tank cap includes a mounting apparatus configured to receive a fuel additive capsule.

4. The evaporative emissions control system of claim 1, further comprising a fuel tank vent passageway in fluid flow communication with the fuel tank and at least partially disposed inside the carburetor.

5. The evaporative emissions control system of claim 4, wherein the fuel tank vent passageway is at least partially disposed in the throat of the carburetor.

6. The evaporative emissions control system of claim 1, wherein the fuel tank cap includes at least one screen configured to retain the fuel vapor adsorption media.

7. The evaporative emissions control system of claim 6, wherein the screen is configured to provide a compressive force to the fuel vapor adsorbent media.

8. The evaporative emissions control system of claim 7, wherein the screen is concave.

9. The evaporative emissions control system of claim 6, wherein the screen is made of stainless steel.

10. The evaporative emissions control system of claim 1, wherein the fuel tank cap includes a restrictor having an aperture.

11. The evaporative emissions control system of claim 10, wherein the fuel cap has a fuel cap housing, wherein the restrictor is adjacent the fuel cap housing to create an interface therebetween, and wherein the restrictor to fuel cap body interface is sealed.

12. The evaporative emissions control system of claim 10, wherein the aperture is substantially centrally-positioned in the restrictor.

13. The fuel tank cap of claim 1, further comprising a substantially centrally-disposed ambient vent positioned substantially near a top of the cap.

14. The evaporative emissions control system of claim 1, wherein the fuel tank cap includes a plurality of spaced vents disposed near the periphery of the fuel tank cap to provide communication with the fuel tank vapor space.

15. The evaporative emissions system of claim 1, wherein the fuel tank has a filler neck disposed at a non-zero acute angle with respect to the top of the fuel tank, to aid in liquid fuel draining from the cap.

16. A fuel tank cap for a fuel tank of an engine, the fuel tank cap comprising:
a cap housing configured to contain a fuel vapor adsorption media; and
a mounting apparatus configured to retain a fuel additive capsule.

17. The fuel tank cap of claim 16, further comprising at least one screen configured to retain the fuel vapor adsorption media.

18. The fuel tank cap of claim 16, wherein the screen is configured to apply a compressive force to the fuel vapor adsorbent media.

19. The fuel tank cap of claim 18, wherein the screen is concave.

20. The fuel tank cap of claim 17, wherein the screen is made of stainless steel.

21. The fuel tank cap of claim 16, further comprising a restrictor having a substantially centrally-disposed aperture therein.

22. The fuel tank cap of claim 21, wherein the restrictor is disposed adjacent to the fuel cap housing to create an interface between, and wherein the interface is sealed.

23. The fuel tank cap of claim 16, further comprising a substantially centrally-disposed ambient vent positioned substantially near a top of the cap housing.

24. The fuel tank cap of claim 16, further comprising a fuel additive capsule disposed in the mounting apparatus that includes a fuel stabilizer.

25. The fuel tank cap of claim 16, further comprising a plurality of spaced vents near the periphery of the fuel tank cap.

26. The fuel tank cap of claim 16, wherein the mounting apparatus further comprises a protrusion configured to create a vent hole in the fuel additive capsule.

27. The fuel tank cap of claim 16, further comprising a restrictor having a substantially centrally-disposed aperture therein and a substantially centrally-disposed ambient vent positioned substantially near a top of the cap housing.
